(19) United States
(12) Patent Application Publication
(10) Pub. No.: US 2014/0236780 A1
(43) Pub. Date: Aug. 21, 2014

(54) METHOD OF MANAGING PRODUCTS

(71) Applicant: VIDEOJET TECHNOLOGIES INC., Wood Dale, IL (US)

(72) Inventors: Andrew Weightman, Chicago, IL (US); John Kirschner, Crystal Lake, IL (US); Michael Kozee, Wheaton, IL (US); David Overholt, Brookfield, IL (US); Daniel Ryan, Sycamore, IL (US)

(21) Appl. No.: 14/350,152

(22) PCT Filed: Oct. 8, 2012
(86) PCT No.: PCT/US2012/059177

§ 371 Date: Apr. 7, 2014

Related U.S. Application Data
(60) Provisional application No. 61/545,310, filed on Oct. 10, 2011.

(51) Int. Cl. G06Q 10/08

(52) U.S. Cl. CPC G06Q 10/087
USPC 705/28

(57) ABSTRACT

A method of managing products includes providing a plurality of products in a first arrangement in an environment. Each product includes a respective code indicative of a date. Each code has a first appearance under ambient lighting conditions in the environment and a second appearance when exposed to a predetermined radiation source. The second appearance is more visible to an observer in the environment than the first appearance. The predetermined radiation source is applied to the code to reveal the second appearance of the code. Each of the plurality products is viewed to determine if the respective code meets predetermined criteria. The products are moved into a second arrangement in the environment based on whether the respective code meets the predetermined criteria.

### BACKGROUND

The present disclosure relates to a method of managing products using a code on the product that has enhanced visibility under certain conditions.

The expense associated with waste of consumer grocery products in the United States due to expiration of products is estimated in the billions of dollars a year. A significant number of these products expire in distributor warehouses or retailer shelves due to poor stock management. A contributing cause of poor stock management is the difficulty of efficient stock rotation where stock could be displayed and sold on a first-in, first-out basis, ensuring that the expiration of product prior to sale is minimized. The expense of retrieving, disposing of and replacing consumer products that are unsalable due to expiration typically accrues to both retailers and manufacturers. Furthermore, as a significant number of expired products are likely currently not recognized and removed from retail prior to sale, manufacturers likely incur damage to their brands when expired products are inadvertently purchased and consumed, resulting in a negative consumer experience.

Visible “sell by” or “use by” date codes are currently marked on consumer products by a variety of stakeholders, including manufacturers, distributors, retailers, regulators and consumers. These codes are typically printed in very small regions on the product packaging and, hence, are often small and difficult to see. Certain stakeholders, particularly retailers and manufacturers distributing through Direct-Store-Delivery, incur substantial and potentially avoidable costs due to product rendered unsalable because these small codes are not efficiently decipherable.

### BRIEF SUMMARY

The present disclosure provides a system for enhanced identification of product expiration periods in distribution or retail environments. The system significantly improves the speed, efficiency and consistency with which supply chain personnel can identify the manufacture or expiration period of any products in inventory.

In one aspect, a method of managing products includes providing a plurality of products in a first arrangement in an environment. Each product includes a code indicative of a date. Each code has a first appearance under ambient lighting conditions in the environment and a second appearance when exposed to a predetermined radiation source. The second appearance is more visible to an observer in the environment than the first appearance. The predetermined radiation source is applied to the code to reveal the second appearance of the code. Each of the plurality products is viewed to determine if the respective code meets predetermined criteria. The products are moved into a second arrangement in the environment based on whether the respective code meets the predetermined criteria.

At least one of the plurality products may be removed from the environment if the respective code meets the predetermined criteria.

The predetermined radiation source may be in the ultraviolet range, the visible range, or the infrared range.

The product may be a beverage container or a food container.

The environment may be a retail environment or a storage environment.

The code may be an expiration date or a sell by date.

The product further may include a second code indicative of the date, the second code visible under ambient conditions.

The code may be printed on the products with an ink jet printer or a laser.

The code may include an ink that fluoresces in response to a certain frequency of light.

The ink may include at least one luminescent dye, or at least two or three luminescent dyes. The dye may be a laser dye.

A filter may be used to improve the resolution of the second appearance of the code to a user.

The product may include a laser absorptive material that has been activated with a laser of a specific wavelength.

In another aspect, a method of managing products includes providing a plurality of products in a first arrangement in an environment. Each product includes a code indicative of a date, wherein each code has a first appearance under ambient lighting conditions in the environment and a second appearance when viewed through an optical filter. The second appearance is more visible to an observer in the environment than the first appearance. The code is viewed through the optical filter to reveal the second appearance of the code. Each of the plurality products is viewed to determine if the respective code meets predetermined criteria. The plurality of products is moved into a second arrangement in the environment based on whether the respective code meets the predetermined criteria.

The foregoing paragraphs have been provided by way of general introduction, and are not intended to limit the scope of the following claims. The presently preferred embodiments, together with further advantages, will be best understood by reference to the following detailed description taken in conjunction with the accompanying drawings.

### BRIEF DESCRIPTION OF THE DRAWINGS

FIG. 1 is a schematic showing a plurality of products in a first arrangement.

FIG. 2 is a schematic showing a plurality of products in a second arrangement.

FIG. 3 is a picture of a bottle cap marked with an ink shown in ambient conditions.

FIG. 4 is a picture of the bottle cap of FIG. 3 when illuminated with ultraviolet light.

### DETAILED DESCRIPTION

The invention is described with reference to the drawings in which like elements are referred to by like numerals. The relationship and functioning of the various elements of this invention are better understood by the following detailed description. However, the embodiments of this invention as described below are by way of example only, and the invention is not limited to the embodiments illustrated in the drawings.

The present disclosure provides a system for enhanced identification of product expiration period in distribution or retail environments. This system is intended for use by manufacturers, distributors or retailers in the management of stock rotation. Importantly, this system significantly improves the speed, efficiency and consistency with which supply chain employees (i.e., stock workers) can identify the manufacture time frame or expiration period of an individual consumer product.

In one embodiment, the system features the marking of consumer packaged goods with human readable code or a machine decipherable symbological mark using a fluorescent ink indicating the product's manufacture date, sell-by date, or expiration period, combined with use of a handheld/portable radiation or light source for illumination of the fluorescent codes or marks for quick identification and reading. The format of the code can vary; the code does not specifically have to be a sell by date, but could be, e.g., a production date in any format or other code that is indicative of a sell-by, use-by, or similar date.

In many cases, the system disclosed herein is not intended to replace the date and lot codes currently marked on most consumer packaged goods. Those codes are most often intended to be both discrete and to provide manufacturers with quality assurance and/or traceability. Rather, the system is generally intended to supplement those codes by providing retailers and distributors with a highly visible cue to alert their supply chain employees of the presence of products approaching or past their expiration date that happen to be mixed together with the same products that are within their intended shelf life. Importantly, the system provides highly visible cues to retailer/distributor employees when illuminated with the predetermined radiation source, that is largely invisible or unnoticeable under normal lighting conditions (i.e., in the absence of the radiation source). The benefit of this difference is that consumers are not distracted by a visual cue intended only for retailers and distributors from the other important packaging facets: i.e., the package aesthetics/design, the printed brandings, ingredient or other information. However, in some embodiments, the present system can be used by itself to provide the only code without an additional date or lot code on the product.

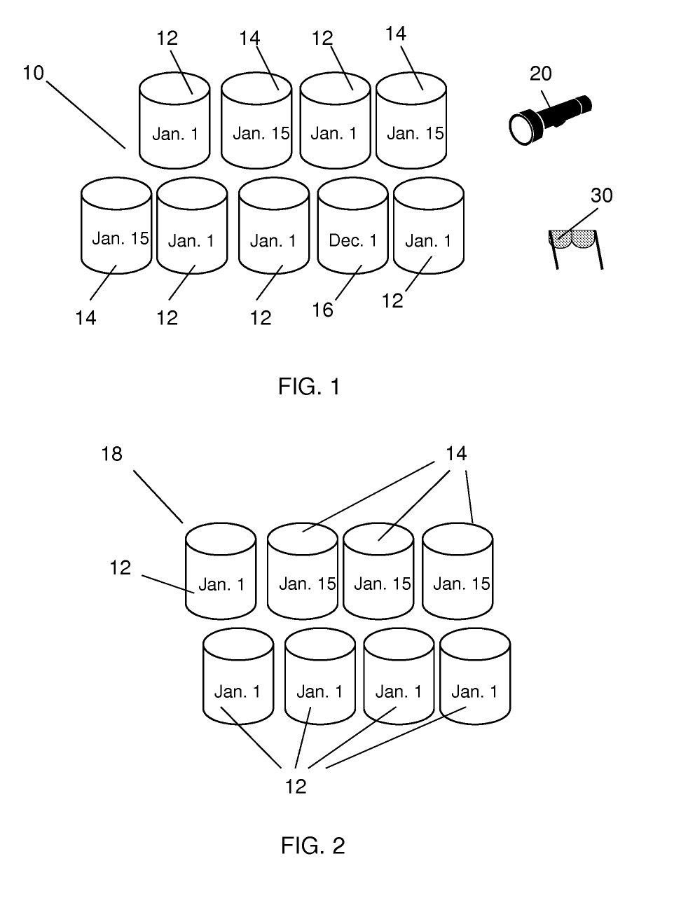

The method of managing the products includes providing a plurality of products in a first arrangement in an environment. FIG. 1 is a schematic showing a plurality of products in a first arrangement 10. The products may be, for example, beverages or food containers. The products could also be things like pharmaceutical products, hospital supplies, or any other item with an expiration date. The arrangement may be, for example, the position of the products on a shelf. The environment may be a retail environment such as a grocery store or a distribution location or storage environment such as a warehouse. Each product includes a code indicative of a date. The code may be, for example, an expiration date, sell-by date, use-by date, born on date, or the like, in any convenient format. The code is preferably in human readable format. Alternatively, the code may be in machine readable format (e.g. 1-D or 2-D bar code).

Each code has a first appearance under ambient lighting conditions in the environment and a second appearance when exposed to a predetermined radiation source. Thus, the first appearance may be under typical fluorescent or incandescent white light in a retail store. The second appearance presents when the code is exposed to radiation of a specific kind such as ultraviolet, infrared, or specific portion of the visible light spectrum. The second appearance is more visible in some way to an observer in the environment than the first appearance. In the first appearance, the code may be invisible, nearly invisible, or otherwise obscured or not readily discernible to an observer. The second appearance may be more visible because it brighter than the surrounding background or in some way more easily discernible to a user than the first appearance. The brightness may be due to fluorescence, phosphorescence, photoluminescence or bioluminescence of the mark as a response to the radiation applied. The second appearance may also appear darker than the surrounding background. This may be due to increased absorption, or diffraction of the mark in comparison with the surrounding background.

To view the second appearance of the code, a user applies the predetermined radiation source to the code to reveal the second appearance of the code. The user normally will view each of the products to determine if the codes (i.e., symbological values or human readable elements) printed on the products indicate that the respective products require redistribution or removal. The products are then rearranged and/or removed as necessary. For example, a stock worker may use this methodology to adjust the stock on the shelf. Products that have a later expiration date may be moved to the back of a shelf, while those with a nearer expiration date may be moved to the front of a shelf. If the products indicate an expiration date that has already passed, then the relevant products may be removed from the environment, for example to be thrown out. In embodiments wherein the code is not readily discernible to a consumer in the ambient environment, the code does not distract from the desired product packaging appearance.

The system may be used in an environment where it is desirable to have a code that is not readily visible to the consumer but can be made visible to those with the proper knowledge. For example, the date could be used to verify that a warranty is still in effect for a product. The system may also be used in other situations where a visible code would detract from the appearance of the item. For example, the code may be used with toys or artwork so that a trained user could ascertain the code, but the code would not be readily visible to the average user, thus avoiding detracting from the appearance of the item.

The process is illustrated in FIGS. 1 and 2. FIG. 1 is a schematic showing a plurality of products in a first arrangement 10. In FIG. 1, products 12 have a first upcoming expiration date, products 14 have a later upcoming expiration date, and product 16 have an expiration date that has already passed. In FIG. 2, the products have been rearranged to a second configuration 18. Expired product 16 has been removed, and products 12 with a nearer expiration date have been moved to the front of a shelf, while products 14 with a later expiration date have been moved to the back of a shelf. Radiation source 20 and/or filter 30 may be used to see and/or enhance the code on the products.

Full commercial implementation of the system describe herein may include the following. The manufacturer of a consumer packaged good uses a continuous ink jet (CIJ) printer or similar coding, printing, or laser marking device to apply a code, symbol or cue directly on the product packaging. For example, a CIJ printer may be used to print an ultraviolet (UV) fluorescent mark. Supply chain employees handling this manufacturer's product are equipped with a light radiation source that is capable of exciting the UV fluorescent mark. Additionally, these employees are trained to be able to interpret the human readable code or are provided with means to decipher the code in the case of a machine decipherable code. During distribution, shelf stocking, restocking or rotation of the product, the stock worker illuminates products with the handheld light and quickly identifies relative ages of individual units or batches of units. Supply chain employees use the illuminated code to quickly rotate product stock (i.e. inventory) such that oldest stock is sold first. Additionally, employees efficiently remove expired inventory before sale to consumer, thus protecting consumers from consumption or use of expired product.

The radiation source may be any suitable source that is selected to elicit the desired code properties. The radiation source may in the ultraviolet range (10 nm to 400 nm), specific portions of the visible range (400 nm to 740 nm), or in the infrared range (740 nm to 300 μm). It is most desirable that the radiation source include one where the energy emitted is relatively discrete or narrow energy width, such as is characterized by LED, laser, low pressure mercury vapor lamp, or laser diode radiation source. These kinds of light sources are relatively discrete with respect to their emitted energies when compared with a traditional light source such as a blackbody source (incandescent bulb), a fluorescent noble gas filled source (such as a fluorescent tube), or high pressure metal containing bulbs (such as mercury, or sodium vapor).

The radiation source may be specifically an ultraviolet radiation source with a peak intensity wavelength between 330 and 450 nm or more specifically one with a wavelength between 375 and 410 nm. In one embodiment, the ink absorbs UV light between about 200 and 420 nm and emits orange or red fluorescent light between about 500 and 700 nm.

The radiation source may further be a visible light source such as a visible LED light or combination or LEDs with specific relatively discrete wavelengths. For example, the light source may be a white LED light which is sometimes a combination of different colored LEDs.

The radiation source may further be an infrared radiation source. One particularly advantaged IR radiation source is one with a wavelength of around 1470 nm or greater. An infrared readable dye may provide greater contrast over the background than dyes that fluoresce from ultraviolet light.

The code may be formed by an ink that includes one or more luminescent materials (dyes or taggants). Luminescence is defined here as exhibiting the property of fluorescence, phosphorescence, photoluminescence, bioluminescence, and the like. One issue is that it would be desirable to use a single ink to provide the code for all colors of substrate; however, if the ink emits light at a wavelength that is not absorbed by the substrate or similar to the wavelength of the radiation source (within about 50 nm or less at peak irradiance) it may be more difficult for a user to see. Thus, it may be desirable to have the code emit light of two or more wavelengths so that the code is visible regardless of the substrate or incident radiation. In one embodiment, the ink includes a plurality (such as two, three, or four) of luminescent materials or dyes. Each dye may be activated by a different wavelength of light (in the UV, visible, or IR range), so that the combined luminescence of the plurality of dyes provides a more visible code across a wider arrange of substrate colors than any of the dyes alone. Thus, an advantage of certain embodiments of the present system is that the code is visible regardless of the color of the substrate it is printed on.

A preferred suitable radiation source would be one where the source is designed to emit multiple radiation bands wherein each band overlaps or is coincident in energy with the excitation wavelength ranges for the luminescent materials or dyes. Hence, the radiation source itself may be visible or invisible, with the luminescent materials selected to show a highly visible code under illumination. The light source may use filters or several LED colors to provide the desired wavelengths. Alternatively, the luminescent materials may be selected to work in unison with a relatively simple light source. For example, a light source exhibiting a narrow singular emission peak may be employed with multiple luminescent materials that have overlapping, coincident excitation bands.

In yet a further embodiment, the excitation bands of the various luminescent materials may overlap by design with the emission or fluorescence bands of separate luminescent materials in the inks. Hence, by exciting (inducing luminescence in) a first species using a given radiation wavelength, a second luminescent species with a different excitation energy range may be subsequently excited by the energy emitted by the first species. Also, subsequent emission of energy by a second species may overlap with the excitation band of a third species, causing further luminescence in a third species, and so forth.

In one embodiment, a suitable ink for providing the code includes an organic solvent (such as MEK or cyclohexanone), a binder resin, and a luminescent dye. A suitable ink for use in a continuous inkjet printer is an ultraviolet fluorescing ink (commercially available from Videojet Technologies Inc. as 16-5710). Another suitable ink is disclosed in pending U.S. Application Ser. No. 61/591,666, filed Jan. 27, 2012, the contents of which are hereby incorporated by reference.

In one embodiment, the code is provided by an ink that includes porous microspheres. The microsphere-containing ink is illuminated with a light source using a specific wavelength. In another embodiment, the code is made from an ink that includes a laser dye. In yet another embodiment, the microspheres may act to bind to or encapsulate the laser dye creating radiation excitable luminescent materials with distinct wavelengths that do no interact with one another in solution.

In one embodiment, the method may include the use of special glasses to be worn by the user that acts to filter the reflected light from the code or the surrounding unprinted area. By filtering out unwanted light, the perceived visibility of the marks might be increased. Examples of undesirable reflected light might include any of the following: light reflected back from the substrate emitted from the same radiation source used to view the second appearance; normally reflected ambient light that is close in energy to the light resulting from the luminescence of any particular luminescent material; or, light emitted from one or more of the luminescent materials so as to provide greater visibility to the light emitted from other luminescent materials in the mark. The filter will generally act to selectively transmit or block of a certain wavelength and/or polarization. Thus, the lenses may further be polarized to enhance the contrast between the code and the substrate.

The code or mark may further include one or more dyes (separately or in combination with the luminescent materials mentioned above) that are strongly absorptive at particular regions in the visible spectrum. When illuminated with a light at a wavelength coincident with these dyes, the impression of a dark mark would be visible against the unprinted substrate. For example, a dye with a strong and relatively discrete absorption at 650 nm may be printed onto a red background. This mark might appear relatively invisible, as the reflected wavelengths between the printed mark and the background would similar. However, the mark when illuminated with an LED emitting strongly at the same energy (650 nm) might appear black in comparison with the background.

In another embodiment, the product is coated with a laser absorptive material (such as those available from Datalase, Inc.). After a portion of the product is coated with the absorptive material, the material is activated with a laser using laser intensity specific to the color of the product (e.g. the color of a bottle cap) for maximum code contrast and of specific wavelength. The code is then illuminated by the user with a light of the same wavelength as the laser marking device to ascertain the code.

In another embodiment, the code is viewed under ambient light and a filter is used to allow the user to clearly see the code. For example, similar to previously described, special glasses may be worn by the user that act to filter some range of light from the code or the surrounding unprinted area to make the code clearly visible to the user. For example, the code and the background may be of such complimentary colors that under ambient light the code is not clearly visible, but the filter removes some portion of the color of the background image to allow the code to be visible. The filter will generally act to selectively transmit or block of a certain wavelength and/or polarization. In one embodiment, the code is provided by materials with a different refractive index or gloss than the substrate, and an optical filter enhances the appearance of the code.

In short, appropriate use of the visual cue system described herein allows retail stock to be rotated more efficiently with oldest product displayed and sold first. The result is reduced waste and expense incurred by manufacturers and retailers from product that is unsellable due to expiration. Labor costs associated with stock rotation are also reduced. Additionally, fewer expired products are inadvertently left on shelves and sold to consumers. This ensures that fewer consumers are exposed to the potentially negative experience of consuming an expired product that may exhibit impaired taste, nutrition or safety characteristics. This also clearly benefits the reputation of manufacturers' and/or retailers' brands.

### EXAMPLE

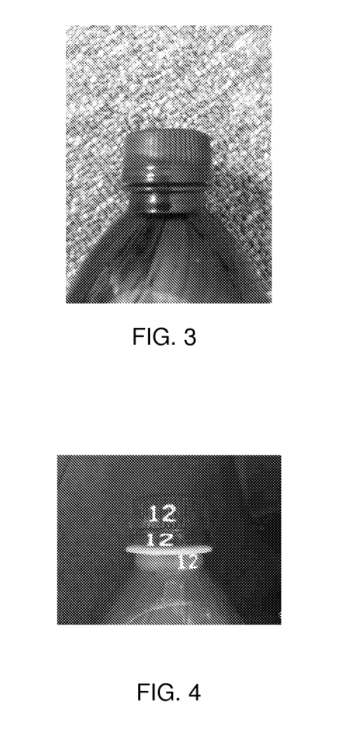

An ultraviolet fluorescing ink (commercially available from Videojet Technologies Inc. as 16-5710) was applied to a bottle cap with a continuous ink jet printer. FIG. 3 shows the bottle and cap illuminated with normal ambient indoor fluorescent lighting. FIG. 4 shows the bottle and cap illuminated with a UV light source. It can be seen that the code is essentially invisible to the eye under ambient conditions, but easily discernible with the appropriate illumination. The UV light source in FIG. 4 was a commercially available 21 LED handheld UV light with an approximate energy at maximum emission of 395 nm.

The described and illustrated embodiments are to be considered as illustrative and not restrictive in character, it being understood that only the preferred embodiments have been shown and described and that all changes and modifications that come within the scope of the inventions as defined in the claims are desired to be protected. It should be understood that while the use of words such as “preferable”, “preferably”, “preferred” or “more preferred” in the description suggest that a feature so described may be desirable, it may nevertheless not be necessary and embodiments lacking such a feature may be contemplated as within the scope of the invention as defined in the appended claims. In relation to the claims, it is intended that when words such as “a,” “an,” “at least one,” or “at least one portion” are used to preface a feature there is no intention to limit the claim to only one such feature unless specifically stated to the contrary in the claim. When the language “at least a portion” and/or “a portion” is used the item can include a portion and/or the entire item unless specifically stated to the contrary.

What is claimed is:

1. A method of managing products comprising:
providing a plurality of products in a first arrangement in an environment, each product comprising a respective code indicative of a date, wherein each code has a first appearance under ambient lighting conditions in the environment and a second appearance when exposed to a predetermined radiation source, where the second appearance is more visible to an observer in the environment than the first appearance;
applying the predetermined radiation source to the code to reveal the second appearance of the code;
viewing each of the plurality products to determine if the respective code meets a predetermined criteria; and
moving the plurality of products into a second arrangement in the environment based on whether the respective code meets the predetermined criteria.

2. The method of claim 1 further comprising removing at least one of the plurality products from the environment if the respective code meets the predetermined criteria.

3. The method of claim 1 wherein the predetermined radiation source is in the ultraviolet range.

4. The method of claim 3 wherein the ink absorbs UV light between about 200 and 420 nm and emits orange or red fluorescent light between about 500 and 700 nm.

5. The method of claim 1 wherein the predetermined radiation source is in the visible range.

6. The method of claim 1 wherein the predetermined radiation source is in the infrared range.

7. The method of claim 1 wherein the product is a beverage container.

8. The method of claim 1 wherein the product is a food container.

9. The method of claim 1 wherein the environment is a retail environment.

10. The method of claim 1 wherein the environment is a storage environment.

11. The method of claim 1 wherein the code is an expiration date or a sell by date.

12. The method of claim 1 wherein the product further comprises a second code indicative of the date, the second code visible under ambient conditions.

13. The method of claim 1 wherein the code is printed on the products with an ink jet printer.

14. The method of claim 1 wherein the code is applied to the products with a laser.

15. The method of claim 1 wherein the code comprises an ink that fluoresces in response to a certain frequency of light.

16. The method of claim 15 wherein the ink comprises at least one luminescent dye.

17. The method of claim 15 wherein the ink comprises at least two luminescent dyes.

18. The method of claim 15 wherein the ink comprises a laser dye.

19. The method of claim 1 further comprising using a filter to improve the resolution of the second appearance of the code to a user.

20. The method of claim 1 wherein the product comprises a laser absorptive material that has been activated with a laser of a specific wavelength.

21. A method of managing products comprising:
providing a plurality of products in a first arrangement in an environment, each product comprising a respective code indicative of a date, wherein each code has a first appearance under ambient lighting conditions in the environment and a second appearance when viewed through an optical filter, where the second appearance is more visible to an observer in the environment than the first appearance;
viewing the code through the optical filter to reveal the second appearance of the code;
viewing each of the plurality products to determine if the respective code meets a predetermined criteria; and
moving the plurality of products into a second arrangement in the environment based on whether the respective code meets the predetermined criteria.

22. The method of claim 21 further comprising removing at least one of the plurality products from the environment if the respective code meets the predetermined criteria.

23. The method of claim 21 wherein the product is a beverage container.

24. The method of claim 21 wherein the product is a food container.

25. The method of claim 21 wherein the environment is a retail environment.

26. The method of claim 21 wherein the environment is a storage environment.

27. The method of claim 21 wherein the code is an expiration date or a sell by date.
